(19) United States
(12) Patent Application Publication
(10) Pub. No.: US 2013/0300124 A1
(43) Pub. Date: Nov. 14, 2013

(54) Profiled Air Cap on Direct Drive Wind Turbine Generator

(71) Applicants: Anthony Chobot, Goleta, CA (US); Tyler Mayer, Carpinteria, CA (US); Amir Mikhail, Santa Barbara, CA (US); Michael Chartre, Watertown, WI (US); Frank Klein, (US); Edwin Hahlbeck, (US)

(72) Inventors: Anthony Chobot, Goleta, CA (US); Tyler Mayer, Carpinteria, CA (US); Amir Mikhail, Santa Barbara, CA (US); Michael Chartre, Watertown, WI (US); Frank Klein, (US); Edwin Hahlbeck, (US)

(73) Assignee: Clipper Windpower, Inc., Carpinteria, CA (US)

(21) Appl. No.: 13/469,777

(22) Filed: May 11, 2012

(51) Int. Cl. F03D 9/00

(52) U.S. Cl. 290/55

(57) ABSTRACT

A direct drive wind turbine and an electric generator for the wind turbine are disclosed. The generator may include a stator, a rotor spaced apart from the stator and a main shaft defining an axis of rotation, the main shaft at least indirectly connected to the generator rotor. The generator may also include a bearing assembly supporting the main shaft and defining a center of deflection on the axis of rotation. The generator may further include a convexly profiled air gap defined between the stator and the rotor, the air gap having a maximum width in regions of maximum deflection and a minimum width in regions of minimum deflection, the regions of maximum and minimum deflection determined with respect to the center of deflection.

### FIELD OF THE DISCLOSURE

The present disclosure generally relates to wind turbines and, more particularly, relates to electrical generators of direct drive wind turbines.

### BACKGROUND OF THE DISCLOSURE

A direct drive wind turbine includes a set of two or three large rotor blades mounted to a hub. The rotor blades and the hub together are referred to as the rotor. The rotor blades aerodynamically interact with wind and create lift, which is then translated into a driving torque by the rotor. The rotor of the direct drive wind turbine is directly coupled to a generator, typically to a rotor of the generator, without any speed increasing gearbox therebetween. By virtue of connecting the rotor of the direct drive wind turbine directly to the generator, this topology eliminates the complexity and expense of the gearbox that is typically found in a conventional wind turbine.

Given that the direct drive generator is directly coupled to the rotor of the wind turbine, the generator turns at the same low speed as the rotor. By turning at the low rotor speeds of the wind turbine, the generator exacts a number of trade-offs. For instance, a direct drive generator is typically constructed so that it is very large in diameter. The large diameter in part results in the need to increase the surface speed of the rotor relative to the stator to minimize the amount of active material in the generator. However, with such a large generator, and with the rotor of the generator directly coupled to the rotor of the wind turbine, large deflections can occur between the rotor and the stator of the generator. Specifically, transient dynamic effects and large aerodynamic moments can cause deflections of the wind turbine's rotor. These deflections can be transferred to the generator because of its direct coupling with the wind turbine rotor, causing the generator rotor and stator to deflect relative to one another. Such generator deflections are particularly relevant to the large generators of a modern multi-megawatt direct drive wind turbine.

To counteract the deflections in a direct drive wind turbine generator, the air gap between the rotor and stator must be designed large enough so that the largest expected deflections do not result in contact between the rotor and stator during operation. Any contact between the rotor and the stator can cause catastrophic failure of generator components and possibly the wind turbine. Generally speaking, as the diameter and/or stack length of the generator increases, the propensity of the generator to encounter large deflections increases as well; and so the air gap between the rotor and the stator must be made larger to accommodate those deflections. Larger air gaps reduce the performance of the generator in a known manner. Alternatively, the air gap can be minimized by increasing the stiffness of the generator's internal structure and supporting structure to minimize the relative deflections between the rotor and stator. However, this increased stiffness is generally accomplished by increased size, weight, complexity, and cost of the structures, especially in a direct drive generator which generally has a large diameter.

Accordingly, it would be beneficial if an effective mechanism were developed that could account for the deflections within the rotor and the stator, while minimizing the required width of the air gap.

### SUMMARY OF THE DISCLOSURE

In accordance with at least some embodiments of the present disclosure, a wind turbine is disclosed. The wind turbine may include a wind turbine rotor comprising a hub and a plurality of blades radially extending from the hub. The wind turbine may further include an electric generator operatively driven by the wind turbine rotor. The electric generator may comprise a generator stator, a generator rotor spaced apart from the generator stator, and a main shaft defining an axis of rotation. The main shaft may be at least indirectly connected to the generator rotor for rotation. The electric generator may further comprise a bearing assembly supporting the main shaft and defining a center of deflection on the axis of rotation. The center of deflection may lie in a substantial center of a stack length of the generator. The electric generator may also comprise a profiled air gap defined between the generator stator and the generator rotor with reference to the center of deflection. The air gap may have a maximum width at axial ends of the stack length and a minimum width at the substantial center of the stack length. The maximum width of the air gap may correspond to regions of maximum deflection and the minimum width of the air gap may correspond to regions of minimum deflection of at least one of the generator stator and the generator rotor.

In accordance with some other aspects of the present disclosure, a wind turbine is disclosed. The wind turbine may include a wind turbine rotor directly driving a generator. The wind turbine rotor may comprise a hub and a plurality of blades radially extending from the hub. The generator may comprise a generator stator, a generator rotor spaced apart from the generator stator, and a main shaft defining an axis of rotation. The main shaft may be at least indirectly connected to the generator rotor for rotation. The generator may further comprise a bearing assembly supporting the main shaft, configured to resist deflections of the main shaft, and defining a center of deflection on the axis of rotation, the center of deflection lying substantially longitudinally in-line with the bearing assembly along a stack length of the generator. The generator may further comprise a profiled air gap defined between the generator stator and the generator rotor. The air gap may have a maximum width in regions farthest away from the center of deflection and a minimum width in regions substantially longitudinally in-line with the center of deflection.

In accordance with yet other aspects of the present disclosure, a direct drive fluid-flow turbine is disclosed. The direct drive fluid-flow wind turbine may include a wind turbine rotor having a plurality of rotor blades that interact with the fluid in motion to produce a torque about the wind turbine rotor, the wind turbine rotor supported for rotation on a bearing assembly that minimizes deflections of the wind turbine rotor. The direct drive fluid-flow wind turbine may also include a generator having a generator stator and a generator rotor, the generator rotor being driven by the wind turbine rotor to rotate at the same rotational speed therewith, the generator stator and the generator rotor having an air gap therebetween of sufficient width to avoid mutual contact due to deflections of the generator stator or the generator rotor relative to the other, the generator stator and the generator rotor being positioned radially around the bearing assembly and the air gap width being profiled by convexly curving one of the surface of the generator rotor or the surface of the generator stator, with a greater width of the air gap occurring at each axial end of the air gap and the minimum width of the air gap occurring approximately in the axial middle of the air gap.

### BRIEF DESCRIPTION OF THE DRAWINGS

For a more complete understanding of the disclosed methods and apparatuses, reference should be made to the embodiments illustrated in greater detail on the accompanying drawings, wherein:

FIG. 1 is a schematic illustration, in cut-away and partial cross-section, of a direct drive wind turbine, in accordance with at least some embodiments of the present disclosure;

FIG. 2 is a cross-sectional view of a portion of an exemplary generator that may be employed within the direct drive wind turbine of FIG. 1, in accordance with at least some embodiments of the present disclosure;

FIGS. 3A-3B are exemplary profiles of an air gap between a rotor and a stator of the generator of FIG. 2 in a one bearing configuration, in accordance with at least some embodiments of the present disclosure;

FIG. 4 is a another exemplary profile of the air gap in a one bearing configuration;

FIG. 5 is an exemplary profile of the air gap between the rotor and the stator of the generator of FIG. 2 in a dual bearing configuration; and

FIG. 6 is yet another exemplary profile of an air gap between the rotor and the stator of the generator of FIG. 2.

While the following detailed description has been given and will be provided with respect to certain specific embodiments, it is to be understood that the scope of the disclosure should not be limited to such embodiments, but that the same are provided simply for enablement and best mode purposes. The breadth and spirit of the present disclosure is broader than the embodiments specifically disclosed and encompassed within the claims eventually appended hereto.

### DETAILED DESCRIPTION OF THE DISCLOSURE

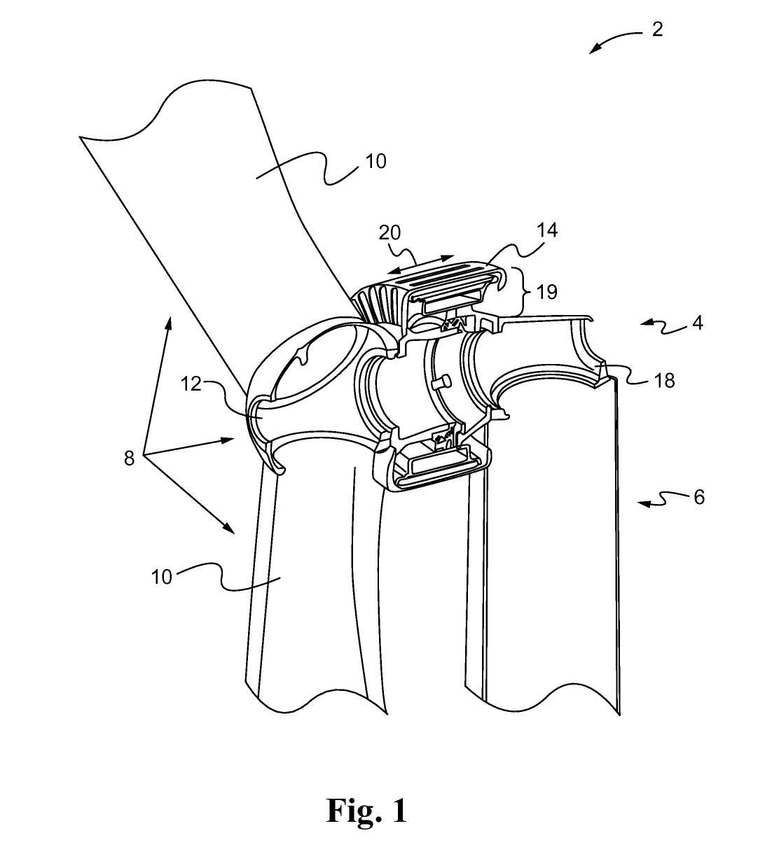

Referring to FIG. 1, an exemplary direct drive wind turbine 2 is shown, in accordance with at least some embodiments of the present disclosure. While all the components of the wind turbine have not been shown and/or described, a typical direct drive wind turbine may include an up tower section 4 and a down tower section 6. The up tower section 4 may include a rotor 8 having a plurality of blades 10 connected to a hub 12. The blades 10 may rotate with wind energy and the rotor 8 may transfer that energy to a generator 14 mounted to rotor 8 and to support structure 18. The generator 14 may rotate along with the rotor 8 to generate power, which may be transmitted from the up tower section 4 through the down tower section 6 to a grid (not shown).

In addition to the components of the wind turbine 2 described above, the up tower section 4 of the wind turbine may include several auxiliary components, such as, a yaw system on which the up tower section 4 may be positioned to pivot and orient the wind turbine in a direction of the wind current or another preferred wind direction, a pitch control system (not visible) situated within the hub 12 for controlling the pitch (e.g., angle of the blades with respect to the wind direction) of the blades 10, and the like. Several other auxiliary components, such as various cooling units, back-up power units, etc., that may be present within the wind turbine 2 are contemplated and considered within the scope of the present disclosure.

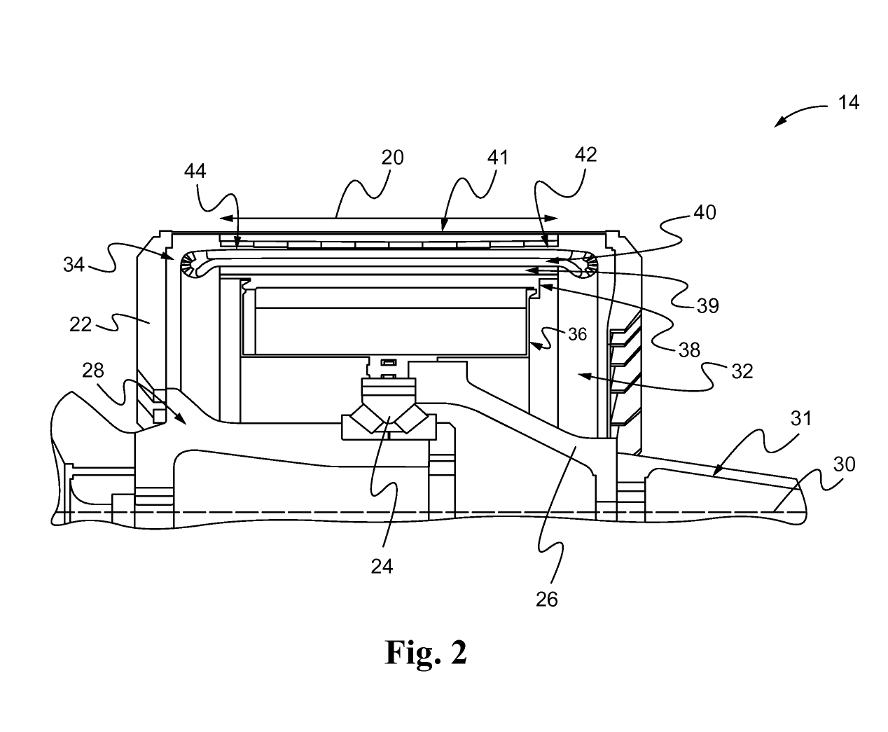

Turning now to FIG. 2, an exemplary cross-sectional view, of a portion 19 (See FIG. 1) of the generator 14 taken along its centerline is shown, in accordance with at least some embodiments of the present disclosure. The stack length of the generator 14 is represented by reference numeral 20 in FIGS. 1 and 2. The stack length may be defined by those of ordinary skill in the art as the length of an air gap between a generator rotor and a generator stator, described below. The components and operation of the generator 14 are well known in the art and accordingly, for conciseness of expression, they have not been described in great detail here. Generally speaking and as shown, the generator 14 may include a housing 22 and a bearing assembly 24 mounted therein by way of a spindle 26. The bearing assembly 24 may support a main shaft 28, as well as the rotor 8. Furthermore, the bearing assembly 24 may be composed of one or more rows of rollers positioned to react the loads imparted on the rotor with a goal of minimizing pivoting of the main shaft 28 and the rotor 8 about the bearing assembly in order to minimize deflections. The main shaft 28 may rotate about an axis of rotation 30 and the spindle 26 may connect the bearing assembly 24 to a base 31 of the support structure 18 for preventing rotation of the bearing assembly. In other words, the spindle 26 may be supported on the base 31 of the support structure 18 on top of the down tower section 6 of the wind turbine 2.

It will be understood although only one of the bearing assembly 24 has been shown in FIG. 2, in at least some embodiments, two bearing assemblies or possibly even more than two may be present. Furthermore, although the bearing assembly 24 has been shown to be mounted substantially at a center of the stack length 20, in other embodiments, the location of the bearing assembly may vary. For example, in at least some embodiments, the bearing assembly 24 may be mounted at or beyond one of the outer ends of the stack length 20, or it may be mounted anywhere in between the center and the outer end positions. The bearing assembly 24 may also be applied to non-inverted generators. Moreover, the type of the bearing assembly 24 used within the generator 14 may vary as well, as will be described further below. Additionally, the bearing assembly 24 may define a center of deflection (also referred to herein as a pivot point or a center of rotation) along the axis of rotation 30. The center of rotation is described in greater detail below.

The generator 14 may also include a stator assembly 32 connected at least indirectly to the bearing assembly 24 and to the base 31, and a rotor assembly 34 mounted at least indirectly to the main shaft 28, in general alignment and spaced away from the stator assembly. In at least some embodiments and, as shown, the rotor assembly 34 may surround the stator assembly 32 in an “inside-out” configuration, while in some other embodiments the rotor assembly may be mounted within the stator assembly for rotation. The stator assembly 32 may include a stator frame 36 having a stator rim 38 on which a plurality of stator laminations 39 and stator windings 40 may be mounted. The rotor assembly 34 on the other hand may include a rotor frame 41 having a plurality of magnets (e.g., permanent magnets) 42 mounted circumferentially thereon and facing the stator windings 40. In at least some embodiments, the diameter of the rotor assembly 34 may be at least twice that of the stack length 20.

An air gap 44 is defined between the stator assembly 32 and the rotor assembly 34. Specifically, the air gap 44 may be an annular air gap that may be defined between the magnets 42 of the rotor assembly 34 and the stator windings 40 of the stator assembly 32. The air gap 44 is a profiled air gap designed to minimize the air space between the stator assembly 32 and the rotor assembly 34, while accounting for any relative deflections that may occur between those components, thereby avoiding contact therebetween. While the bearing assembly 24 may help in minimizing deflections between the stator assembly 32 and the rotor assembly 34, the bearing assembly cannot completely arrest the deflections because it is not infinitely stiff. The air gap 44 is therefore designed to provide sufficient clearance between the rotor assembly 34 and the stator assembly 32 along with the bearing assembly 24 to prevent any contact during operation.

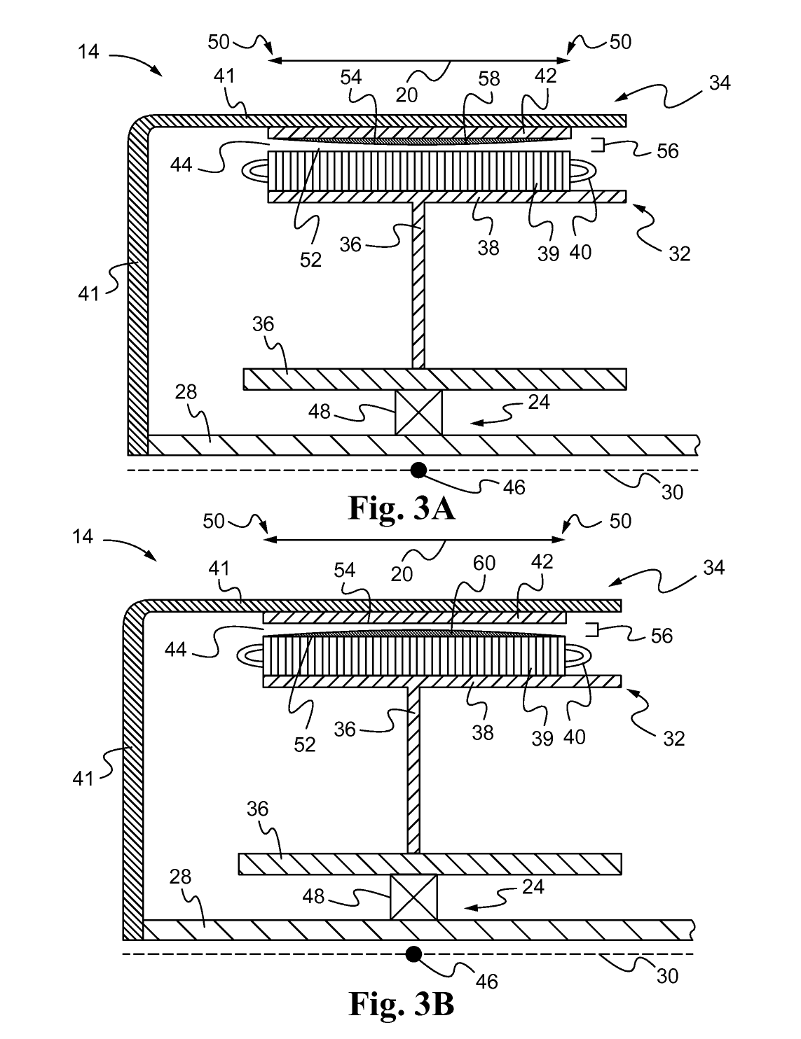

Various profiles of the air gap 44 are described in greater detail below with respect to FIGS. 3A-6. As will also be described below, the air gap 44 may be profiled by contouring surfaces of the stator assembly 32 and/or the rotor assembly 34. It will also be understood that the air gap 44 has been greatly exaggerated in FIGS. 2-6 for purposes of explanation.

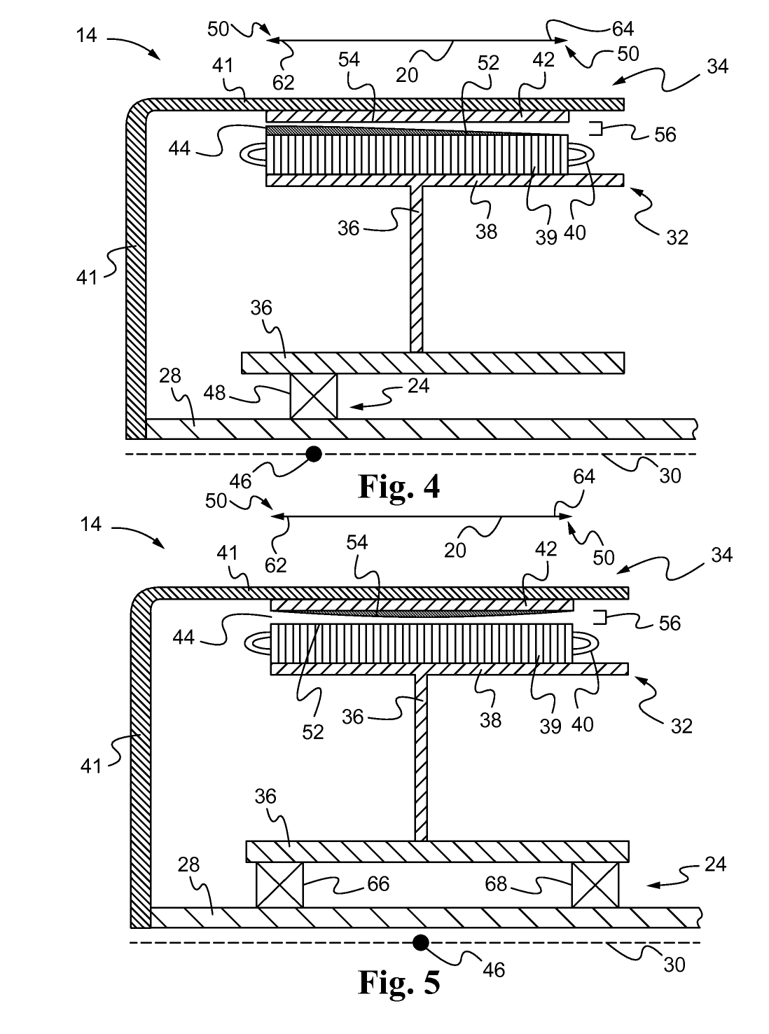

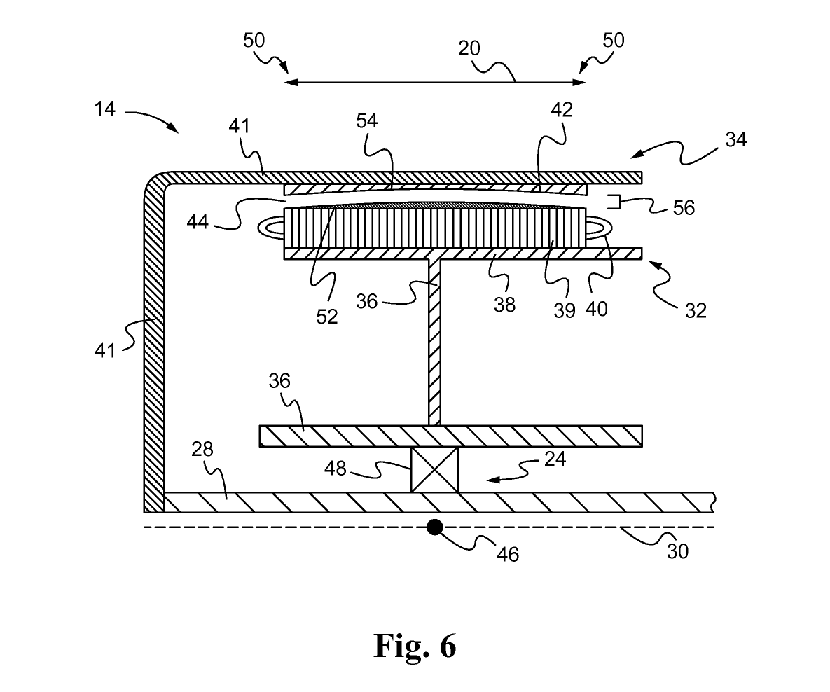

Referring now to FIGS. 3A-6, several exemplary profiles of the air gap 44 are shown, in accordance with at least some embodiments of the present disclosure. In particular, FIGS. 3A-3B and 4 show profiles of the air gap 44 in a one bearing configuration, while FIG. 5 shows a profile of the air gap in a dual bearing configuration. Relatedly, FIG. 6 shows another exemplary profile of the air gap 44 in a one bearing configuration. It will be understood that the profiles of the air gap 44 that are shown in FIGS. 3A-6 are merely exemplary and depict only some of the several profiles of the air gap that are possible. Profiles of the air gap 44 may depend upon the type, location and number of the bearings in the bearing assembly 24 and the center of deflection (described below) defined by the bearing assembly 24.

Furthermore, all of the FIGS. 3A-6 show the generator 14 of FIG. 2 in a simplified schematic illustration with the air gap 44, and the bearing assembly 24 supporting the main shaft 28. The main shaft 28 may rotate about the axis of rotation 30 and define a center of deflection 46. The generator 14 may also include the stator assembly 32 having the stator frame 36 and the stator rim 38 on which the stator laminations 39 and stator windings 40 may be mounted, while the rotor assembly 34 may include the rotor frame 41 having the magnets 42 mounted thereon. The stator assembly 32 and the rotor assembly 34 may define the air gap 44.

With respect to the center of deflection 46, it may be a point that lies on the axis of the rotation 30 about which the rotor assembly 34 may rotate and with respect to which the deflections within the rotor and/or the stator assemblies may be determined. The center of deflection 46 may lie anywhere on the axis of the rotation 30 depending upon several factors, such as, the type of the bearings within the bearing assembly 24, the number of bearings within the bearing assembly and the location of those bearings with respect to the stack length 20. For example, in at least some embodiments, having a single bearing within the bearing assembly 24, the center of deflection 46 may lie on the axis of rotation 30 longitudinally substantially in-line with the bearing. In at least some other embodiments having two or more bearings within the bearing assembly 24, the center of deflection 46 may lie on the axis of rotation 30 at a longitudinally offset distance from one or more of the bearings. Generally speaking, intersection of the apices of the rollers constituting the bearings within the bearing assembly 24 with the axis of rotation 30 may define the point of the center of deflection 46 in embodiments having more than a single bearing within the bearing assembly 24.

Further, although typically the center of deflection 46 may be located as described above, in at least some embodiments and depending upon the type of bearing, the center of deflection need not always lie in-line with the bearing in a single bearing configuration, while the center of deflection may lie longitudinally in-line with one of the bearings in a multiple bearing configuration. Specifically, the type (e.g., internal geometery) of the bearings within the bearing assembly 24 may influence the location of the center of deflection 46 for both single and multiple bearing configurations. For example, one or more of the bearings within the bearing assembly 24 may be constructed to have a single race with a single row of rollers or, alternatively the bearing(s) may have a single race with multiple rows of rollers. In yet other embodiments, one of more of the bearings may have different prescribed cone angles as well. Such various configurations of the bearings may vary the intersection of the roller apices of the bearings with the axis of rotation 30, thereby varying the center of deflection 46. Furthermore, in some embodiments, there may be more than one center of deflection 46 as well.

Referring now specifically to FIGS. 3A and 3B, the bearing assembly 24 may include a single bearing 48 that may be centered (or substantially centered) on the stack length 20 (e.g., positioned in a middle portion of the stack length) of the generator 14. In at least some embodiments and as described above, the location of the center of deflection 46 may correspond (e.g., be longitudinally in-line) to the location of the single bearing 48. Accordingly, when the single bearing 48 is located in a center (or substantial center) of the stack length 20, the center of deflection 46 may also be centered (or substantially centered) along the stack length and may lie on the axis of rotation 30. By virtue of the center of deflection 46 being centered (or substantially centered) along the stack length 20, the greatest deflections within the stator and/or the rotor assemblies 32 and 34, respectively, may occur in regions corresponding to axial ends 50 of the stack length of the generator, while minimum deflections may occur in regions corresponding to the center (or substantial center) of the stack length. By virtue of knowing the regions of greatest deflection, the air gap 44 may be profiled such that the maximum width of the air gap is in regions corresponding to the regions of maximum deflections. Accordingly, when the greatest deflections occur at the axial ends 50, the air gap 44 may be profiled such that the air gap is maximum at the axial ends 50 and minimum at the center (or substantial center) of the stack length 20 to account for those regions of maximum deflection.

Furthermore, the air gap 44 may be profiled by contouring surfaces 52 and 54 of the stator assembly 32 and/or the rotor assembly 34, respectively. As shown in FIG. 3A, the air gap 44 may be profiled by contouring (e.g., curving, having two or more linear/flat facets angled away from the center of deflection, etc.) the surface 54 of the rotor assembly 34 that faces the air gap. Specifically, the surface 54 may be contoured to have a convex profile such that the air gap 44 attains a width 56 (with the surface 52) that is minimum at an apex 58 of the convex surface and maximum at the axial ends 50. The surface 52 of the stator assembly 32 may continue to assume a uniform cylindrical profile. Relatedly, as shown in FIG. 3B, in at least some embodiments, rather than contouring the surface 54 of the rotor assembly 34, the surface 52 of the stator assembly 32 may be contoured to have a convex profile. Similar to the configuration of FIG. 3A, by contouring the surface 52 into a convex profile, the width 56 of the air gap 44 may be minimum about an apex 60 of the surface 52 and maximum at the axial ends 50 of the stack length 20. In this case, the surface 54 of the rotor assembly 34 may continue to have a uniform cylindrical profile.

In contrast to the configuration of the generator 14 of FIGS. 3A-3B in which the single bearing 48 is positioned in a center (or substantial center) of the stack length 20, in at least some other embodiments, the bearing may be positioned toward one of the axial ends 50, as shown in FIG. 4. In such a configuration, the center of deflection 46 may shift to lie in-line with the single bearing 48 at the axial ends 50 as well. Accordingly, with the single bearing 48 and the center of deflection 46 both lying at an end 62 of the axial ends 50, the deflections that may occur within the stator assembly 32 and/or the rotor assembly 34 may be maximum at an end 64 corresponding to the other of the axial ends. Again, the air gap 44 may be profiled to have the greatest width at the regions corresponding to the regions of maximum deflection. Therefore, the surfaces 52 or 54 of the stator assembly 32 or the rotor assembly 34, respectively, may be contoured such that the width 56 of the air gap 44 is the largest at the end 64 to account for the greatest deflection. As shown, this can achieved by contouring (e.g., smooth stepping or tapering) the surface 52 of the stator assembly 32 to gradually increase the width 56 of the air gap 44 from the end 62 to the end 64.

Although not shown, it will be understood that similar to contouring the surface 52 of the stator assembly 32, in at least some embodiments, the surface 54 of the rotor assembly 34 may be contoured to gradually increase the width 56 of the air gap 44 from the end 62 to the end 64, when the single bearing 48 and the center of deflection 46 are both located toward the end 62. In at least some other embodiments, the single bearing 48 and the center of deflection 46 may be located toward the end 64 instead of the end 62 of the axial ends 50. In those cases, the deflections may be the greatest at the end 62 and the air gap 44 may be profiled such that the width 56 of the air gap is maximum at the end 62 and minimum at the end 64. Again, the air gap 44 may be profiled by contouring (e.g., tapering) the surfaces 52 or 54 of the stator assembly 32 or the rotor assembly 34, respectively. In yet other embodiments, the single bearing 48 and, therefore the center of deflection 46 may be located in any position in between the axial ends 50 and the center (or substantial center) of the stack length 20 with the greatest deflections being in regions farthest away from the center of deflection. The air gap 44 in such instances may be profiled to accommodate the regions of the maximum deflections by contouring the surfaces 52 or 54 such that the width 56 is maximum in the regions of greatest deflections.

While the regions of greatest deflections in the stator assembly 32 and/or the rotor assembly 34 are generally the regions that are farthest away from the center of deflection 46, the actual regions and the amount of deflections may be modeled by known engineering tools and techniques, the description of which is not necessary herein and will be understood by those of ordinary skill in this art, and the pattern and extent of those maximum deflected regions may determine how the air gap 44 may be profiled. For example, a maximum deflection profile may be determined by measuring the deflections of the rotor for all load conditions throughout the entire load range and superimposing these deflections upon one another. By selecting only the maximum deflection at any given position along the stack length, the worst case deflected rotor volume may be established. A specific contour can subsequently be determined therefrom to provide a minimum permissible air gap.

Depending upon several factors, such as, the loads that are applied from the rotor 8, the hub 12 and the support structure 18 onto the generator 14, the type and arrangement of the bearing assembly 24, the location of the center of deflection 46, the offset distance between the bearing and the center of deflection, etc., the regions of maximum deflection may vary. It will also be understood that for a given generator 14, there may be several regions of maximum deflections and several regions of minimum deflections. In such instances, the air gap 44 may be profiled to have the maximum width 56 in all the regions of maximum deflections and a minimum width in all the regions of minimum deflections.

Turning now to FIG. 5, an alternate configuration of the generator 14 is shown. In contrast to the configuration of the generator 14 of FIGS. 3A-4 in which the bearing assembly 24 included the single bearing 48, in the configuration of FIG. 5, the bearing assembly may include a first bearing 66 and a second bearing 68, which in at least some embodiments, may be positioned at the axial ends 50 of the stack length 20. In at least some of those embodiments, the center of deflection 46 may be located at a center (or substantial center) of the stack length 20. Accordingly, as described above, the deflections may be the greatest in regions that are the farthest away from the center (or substantial center) or, in other words, the deflections may be the greatest at the axial ends 50 of the air gap 44. As also described above, with the greatest deflections at the axial ends 50, the air gap 44 may be profiled to have the width 56 be maximum at the axial ends and minimum at the center (or substantial center) of the stack length 20. The air gap 44 may be profiled by contouring (e.g., to have a convex profile) the surface 52 of the stator assembly 32 or as shown, by contouring (e.g., to have a convex profile) the surface 54 of the rotor assembly 34.

In at least some other embodiments, the first bearing 66 and the second bearing 68 may be located in a center portion of the stack length 20, or in any position in between the center and the axial ends 50. The location of the center of deflection 46 in these instances may vary as well. In all of such cases, the regions for maximum deflections may be modeled by engineering tools and the air gap 44 may be profiled to have a maximum clearance in the regions of maximum deflections.

With reference now to FIG. 6, yet another profile of the air gap 44 is shown. The configuration of the generator 14 of FIG. 6 generally corresponds to the configuration of FIGS. 3A-3B in which the single bearing 48 and the center of deflection 46 are located at a center (or substantial center) of the stack length 20. However, in contrast to the air gap 44 of FIGS. 3A and 3B in which the air gap was profiled to have a maximum width in regions of maximum deflections and a minimum width in regions of minimum deflections, the width of air gap 44 in FIG. 6 is substantially constant, but the shape of the air gap 44 is contoured to permit the relative deflections between the generator stator and rotor about the center of deflection 46. Specifically, as shown, the surface 52 of the stator assembly 32 may have a convex profile, while the surface 54 of the rotor assembly 34 may have a concave profile matching the convex profile of the surface 52, such that the width of the air gap 44 remains generally constant. This shape of air gap 44 may be advantageous in certain generator constructions where the deflection closely approximates the rotor pivoting relative to the stator (or the stator pivoting relative to the rotor) around a discrete point, with this air gap maintaining sufficient clearance while minimizing the width along its length. Minimizing the air gap width increases power and efficiency. Furthermore, convex and concave profiles have a similar center and are matched to the center of deflection, such that deflections of the generator about the center of deflection cause the surfaces to rotate relative to each other. Thus, due to its contoured shape, the constant air gap is maintained even under a deflection.

Notwithstanding the exemplary profiles of the air gap 44 and the generator configurations described above, several variations to the above are contemplated and considered within the scope of the present disclosure. For example, while the air gap 44 has been shown with the rotor assembly 34 surrounding the stator assembly 32, in at least some embodiments, the air gap may be similarly profiled as described above with the stator assembly surrounding the rotor assembly. Furthermore, although in FIGS. 3A-5, only one of the rotor assembly 34 or the stator assembly 32 have been shown as having a contoured surface for defining the air gap 44, in at least some embodiments, such as in FIG. 6, both of the rotor assembly and the stator assembly surfaces may be contoured to define the air gap. As also discussed above, the center of deflection 46 need not always be in the center of the stack length 20. Rather, the center of deflection 46 may vary and simulation tools may be employed for modeling the deflections within the generator 14 to profile the air gap 44 with respect to the center of deflection.

Thus, the present disclosure sets forth a direct drive wind turbine having a generator coupled directly to the rotor of the wind turbine. A radial air gap exists between the rotor and stator of the generator. The air gap may be profiled to permit deflection of the rotor and stator relative to one another and prevent mechanical contact or interference between the stator and rotor. Specifically, the air gap may be profiled to have a maximum width in regions of greatest deflections, and a minimum width in regions of minimum deflection. Such a profiled air gap minimizes the radial distance between the rotor and stator to increase the operating efficiency of the generator. Profiling the air gap may also have the benefit of minimizing the changes in voltage or current that may occur during periods of high deflection by maintaining a relatively constant average air gap throughout the range of possible deflections between the stator and rotor.

It will be understood that while the generator and the air gap within the generator have been discussed in relation with a wind turbine, the disclosure may be equally applicable to applications other than wind turbines as well using synchronous or other types of generators and electric motors that may be prone to component deflections. Furthermore, while the disclosure above has been described with respect to a direct drive wind turbine, the disclosure may be applicable to other types of direct drive fluid flow turbines such as a tidal or ocean current powered turbine. It will also be understood that the disclosure may be applicable to non-direct drive generators for wind turbines, such as, including but not limited to, geared generators and medium speed generators, without departing from the scope of this disclosure.

While only certain embodiments have been set forth, alternatives and modifications will be apparent from the above description to those skilled in the art. These and other alternatives are considered equivalents and within the spirit and scope of this disclosure and the appended claims.

We claim:

1. A wind turbine comprising:
a wind turbine rotor comprising a hub and a plurality of blades radially extending from the hub; and
an electric generator operatively driven by the wind turbine rotor, the electric generator comprising:
a generator stator;
a generator rotor spaced apart from the generator stator;
a main shaft defining an axis of rotation, the main shaft at least indirectly connected to the generator rotor for rotation;
a bearing assembly supporting the main shaft and defining a center of deflection on the axis of rotation, the center of deflection lying in a substantial center of a stack length of the generator; and
a profiled air gap defined between the generator stator and the generator rotor with reference to the center of deflection, the air gap having a maximum width at axial ends of the stack length and a minimum width at the substantial center of the stack length, the maximum width of the air gap corresponding to regions of maximum deflection and the minimum width of the air gap corresponding to regions of minimum deflection of at least one of the generator stator and the generator rotor.

2. The wind turbine of claim 1, wherein the generator rotor is positioned inside the generator stator.

3. The wind turbine of claim 1, wherein the generator stator is positioned inside the generator rotor.

4. The wind turbine of claim 1, wherein the air gap is profiled by contouring at least one of the facing surfaces of the generator rotor and the generator stator defining the air gap.

5. The wind turbine of claim 4, wherein the air gap is profiled by convexly contouring at least one of the surfaces of the generator rotor and the generator stator.

6. The wind turbine of claim 4, wherein the air gap is profiled by tapering at least one of the surfaces of the generator rotor and the generator stator.

7. The wind turbine of claim 1, wherein the bearing assembly comprises two roller thrust bearings facing in different directions.

8. The wind turbine of claim 7, wherein the bearings are positioned in a substantial central portion of the stack length.

9. The wind turbine of claim 7, wherein the bearings are positioned at the axial end of the stack length near the center of deflection.

10. A wind turbine comprising:
a wind turbine rotor directly driving a generator, the wind turbine rotor comprising a hub and a plurality of blades radially extending from the hub, the generator comprising:
a generator stator;
a generator rotor spaced apart from the generator stator;
a main shaft defining an axis of rotation, the main shaft at least indirectly connected to the generator rotor for rotation;
a bearing assembly supporting the main shaft, configured to resist deflections of the main shaft, and defining a center of deflection on the axis of rotation, the center of deflection lying substantially longitudinally in-line with the bearing assembly along a stack length of the generator; and
a profiled air gap defined between the generator stator and the generator rotor, the air gap having a maximum width in regions farthest away from the center of deflection and a minimum width in regions substantially longitudinally in-line with the center of deflection.

11. The wind turbine of claim 10, wherein the bearing assembly and the center of deflection are positioned in a substantial center of the stack length.

12. The wind turbine of claim 11, wherein the air gap has the maximum width at axial ends of the stack length and the minimum width at the substantial center of the stack length.

13. The wind turbine of claim 10, wherein the bearing assembly and the center of deflection are positioned at one of two axial ends of the stack length.

14. The wind turbine of claim 13, wherein the air gap has the maximum width at the other of the two axial ends of the stack length and the minimum width at the axial end where the bearing assembly is positioned.

15. The wind turbine of claim 10, wherein the maximum width corresponds to a maximum deflection of at least one of the generator stator and the generator rotor and the minimum width corresponds to a minimum deflection of at least one of the generator stator and the generator rotor.

16. A direct drive fluid-flow turbine, comprising:
a wind turbine rotor having a plurality of rotor blades that interact with the fluid in motion to produce a torque about the wind turbine rotor, the wind turbine rotor supported for rotation on a bearing assembly that minimizes deflections of the wind turbine rotor; and
a generator having a generator stator and a generator rotor, the generator rotor being driven by the wind turbine rotor to rotate at the same rotational speed therewith, the generator stator and the generator rotor having an air gap therebetween of sufficient width to avoid mutual contact due to deflections of the generator stator or the generator rotor relative to the other, the generator stator and the generator rotor being positioned radially around the bearing assembly and the air gap width being profiled by smoothly curving one of the surface of the generator rotor or the surface of the generator stator, with a greater width of the air gap occurring at each axial end of the air gap and the minimum width of the air gap occurring approximately in the axial middle of the air gap.

17. The direct drive fluid-flow turbine of claim 16, wherein the smoothly curved surface of the generator rotor or the generator stator is defined by reference to a center of deflection of the wind turbine rotor.

18. The direct drive fluid-flow turbine of claim 16, wherein the bearing assembly comprises two roller thrust bearings and the bearing assembly and the generator stator are supported on a spindle which is in turn supported on a base structure on top of a wind turbine tower.

19. The direct drive fluid-flow turbine of claim 16, wherein the generator rotor is a permanent magnet rotor with permanent magnets mounted on a surface thereof facing the generator stator.

20. The direct drive fluid-flow turbine of claim 16, wherein the diameter of the generator rotor is at least two times the stack length.
